(19) United States
(12) Patent Application Publication
(10) Pub. No.: US 2019/0228361 A1
(43) Pub. Date: Jul. 25, 2019

(54) SYSTEM FOR TRIGGERING ENTERPRISE-WIDE ACTIONS IN RESPONSE TO DETECTING MONITORED EVENTS FROM DISTRIBUTED FRONT LINE UNITS

(71) Applicant: Bank of America Corporation, Charlotte, NC (US)

(72) Inventors: Milton Stanley Prime, Charlotte, NC (US); Meenakshisundaram Ramaswamy, Jacksonville, FL (US); Kathryn Lindsay Little, Huntersville, NC (US); Norbert George Sonner, Matthews, NC (US)

(21) Appl. No.: 15/880,234

(22) Filed: Jan. 25, 2018

(51) Int. Cl. G06Q 10/06

(52) U.S. Cl. CPC G06Q 10/06315; G06Q 10/067

(57) ABSTRACT

Embodiments of the present invention provide a system for triggering enterprise-wide actions in response to detecting events from distributed front line units. As events are detected, a new incident is identified, along with at least one incident keyword associated with that incident. A triggering escalation action is also identified and transmitted to a specialist tasked with resolving the detected incident. Additionally, a dynamic model of the status of each detected incident, triggering escalation action, detected event, and/or affected front line unit is generated. A user may then input a monitoring theme request, including a particular incident keyword. The dynamic model will then display information associated with all detected incidents, triggering escalation actions, detected events, and affected front line units that are linked to the input incident keyword, thereby presenting a status and other information for every identified incident associated with a theme across a portion of the enterprise.

### BACKGROUND

Managing the occurrence of certain events for distributed individual front line units and triggering responsive escalation actions to those certain events is a resource-intensive task. Currently, each event is identified on an individual basis at a single front line unit, and responsive actions are triggered to address only that incident. Such a response is limiting to an overall enterprise, does not address any underlying or macro incidents, and ultimately is a burden on the resources of the enterprise.

### BRIEF SUMMARY

The following presents a summary of certain embodiments of the invention. This summary is not intended to identify key or critical elements of all embodiments nor delineate the scope of any or all embodiments. Its sole purpose is to present certain concepts and elements of one or more embodiments in a summary form as a prelude to the more detailed description that follows.

Embodiments of the present invention address the above needs and/or achieve other advantages by providing apparatuses (e.g., a system, computer program product and/or other devices) and methods for triggering enterprise-wide actions in response to detecting events from distributed front line units. The system embodiments may comprise one or more memory devices having computer readable program code stored thereon, a communication device, and one or more processing devices operatively coupled to the one or more memory devices, wherein the one or more processing devices are configured to execute the computer readable program code to carry out the invention. In computer program product embodiments of the invention, the computer program product comprises at least one non-transitory computer readable medium comprising computer readable instructions for carrying out the invention. Computer implemented method embodiments of the invention may comprise providing a computing system comprising a computer processing device and a non-transitory computer readable medium, where the computer readable medium comprises configured computer program instruction code, such that when said instruction code is operated by said computer processing device, said computer processing device performs certain operations to carry out the invention.

For sample, illustrative purposes, system environments will be summarized. The system may involve receiving event data associated with a plurality of distributed front line units within an enterprise. The system may then identify, from the received event data, a new event comprising at least an affected front line unit of the distributed front line units and an incident associated with the new event. Next, in some embodiments, the system may compare the affected front line unit and the incident associated with the new event to an incident monitoring database to determine a triggering escalation action associated with the incident and a specialist associated with the incident or the affected front line unit. Finally, the system may also communicate the triggering escalation action to a computing device of the specialist.

In some embodiments, the system may compile the identified new event, the affected front line unit associated with the new event, and the incident associated with the new event with a set of other identified events, other affected front line units, and other incidents associated with the plurality of front line units to generate an incident monitoring model. In some such embodiments, the incident monitoring model may comprise at least one of (i) a chart of the identified new event and the set of other identified events, as compared to status and time to completion information; (ii) a chart of the identified new event and the set of other identified events, as compared to ownership information; (iii) a chart of the identified new event and the set of other identified events, as compared to severity information; (iv) a chart of the identified new event and the set of other identified events, as compared to event data trends for the plurality of front line units within the enterprise; and (v) a map denoting status information for the identified new event and each of the set of other identified events across the enterprise.

The system may include steps of monitoring a status of the new event, determining, based on the monitoring, that the status of the new event is normal, and, in response to determining that the status of the new event is normal, communicate a conclusion notification for the triggering escalation action to the computing device of the specialist. Similarly, the system may involve monitoring a status of the triggering escalation action, determining, based on the monitoring, that the status of the triggering escalation action is complete, and communicate a conclusion notification for the triggering escalation action to the computing device of the specialist.

In some embodiments of the system, receiving the event data comprises establishing a secure dedicated communication link to servers of each of the plurality of front line units and monitoring the servers of each of the plurality of front line units to identify the event data in real time. Alternatively, the system may monitor the servers at each of the plurality of front line units on a periodic (e.g., daily, weekly, and the like) basis to identify the event data. In other embodiments of the system, receiving the event data comprises importing data feeds comprising the event data from each of the plurality of distributed front line units within the enterprise and monitoring the imported data feeds for the new event in real time, on a daily basis, on a weekly basis, and the like.

Furthermore, in some embodiments, the system is additionally configured to, in response to determining the triggering escalation action associated with the incident, determine a priority ranking of the determined triggering escalation action. The system may then determine that the priority ranking of the determined triggering escalation action is below a priority ranking of a different triggering escalation action. In some such embodiments, communicating the triggering escalation action to the computing device of the specialist further comprises communicating instructions to defer execution of the triggering escalation action until the different triggering escalation action is fully executed.

Finally, in some embodiments of the system, the incident monitoring database comprises a relational database that links or associates the event data with stored triggering escalation actions.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a block diagram illustrating a system environment for triggering enterprise-wide actions in response to detecting events from distributed front line units, in accordance with an embodiment of the invention;

FIG. 2 provides a block diagram illustrating the managing entity system of FIG. 1, in accordance with an embodiment of the invention;

FIG. 3 provides a block diagram illustrating the incident monitoring system of FIG. 1, in accordance with an embodiment of the invention;

FIG. 4 provides a block diagram illustrating a computing device system of FIG. 1, in accordance with an embodiment of the invention;

FIG. 5 provides a flowchart illustrating a process for triggering enterprise-wide actions in response to detecting events from distributed front line units, in accordance with an embodiment of the invention;

FIG. 6 illustrates one embodiment of an incident monitoring model, in accordance with embodiments of the invention;

FIG. 7 illustrates one embodiment of an incident monitoring model, in accordance with embodiments of the invention;

FIG. 8 illustrates one embodiment of an incident monitoring model, in accordance with embodiments of the invention; and

FIG. 9 illustrates one embodiment of an incident monitoring model, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Embodiments of the present invention provide a system and method for triggering enterprise-wide actions in response to detecting events from distributed front line units. Additionally, a dynamic model of the status of each action, detected event, and/or front line unit is generated to provide information on the health and welfare of individual front line units and a collective enterprise of front line units as a whole on a real time basis, a daily basis, a semiweekly basis, a weekly basis, a biweekly basis, or the like. When triggered, an enterprise-wide action is transmitted to a computing device of a specialist, along with additional information like the dynamic model. As an action is completed, the dynamic model is updated in real time to provide current status information for each action, detected event, and/or the front line unit within the enterprise.

To accomplish this process, the system may first receive event data associated with a plurality of distributed front line units within an enterprise. Next, the system can identify a new event, where the new event involves a specific incident and a front line unit affected by that specific incident. The system is then able to compare the affected front line unit and incident, as a pair, to a database that links such pairs to the appropriate triggering escalation action to resolve the incident and the specialist that can be tasked with carrying out the escalation action. Once the triggering escalation action and the specialist have been identified, the system can communicate the triggering escalation action to a computing device of the specialist.

Furthermore, the system can generate an incident monitoring model by compiling the identified new event, the affected front line unit, the incident associated with the event, and the determined triggering escalation action associated with the incident with a set of other identified events, other front line units, other incidents, and other triggering escalation actions. Once the model is generated, the system can monitor a status of the new event or of the determined triggering escalation action to determine when the status is normal or otherwise changed. The system can then update the model and communicate the change to the computing device of the specialist.

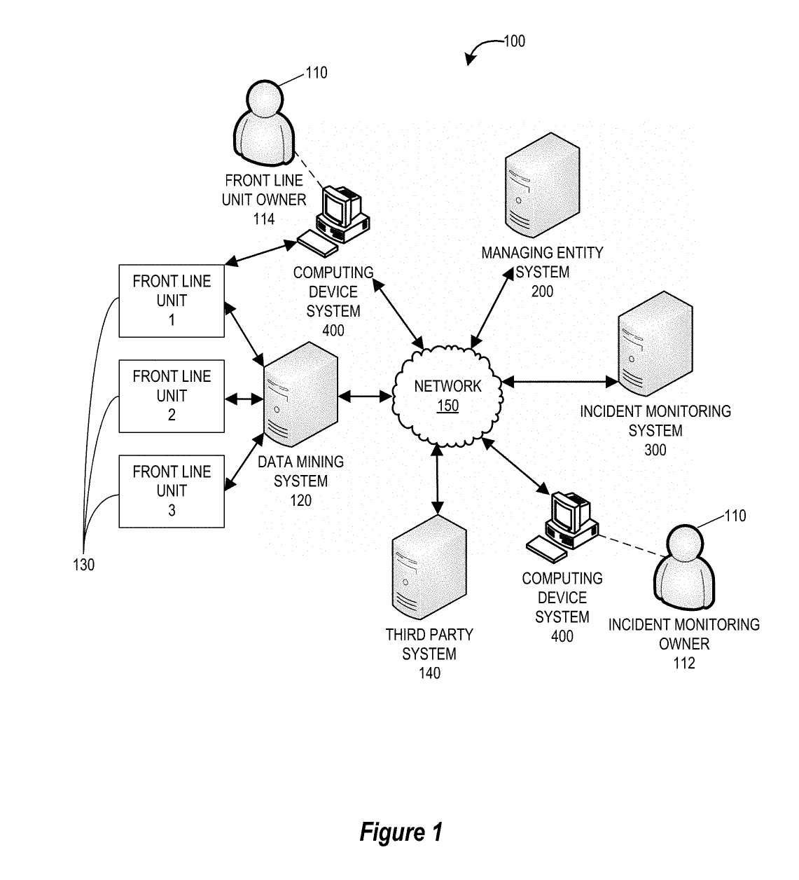

FIG. 1 provides a block diagram illustrating a system and environment 100 for triggering enterprise-wide actions in response to detecting events from distributed front line units, in accordance with an embodiment of the invention. As illustrated in FIG. 1, the environment 100 includes a managing entity system 200, an incident monitoring system 300, one or more computing device systems 400, an incident systems of record 120, a plurality of front line units 130, and one or more third party systems 140. One or more users 110 may be included in the system environment 100 including, but not limited to, an incident monitoring owner 112 and a front line unit owner 114. In some embodiments, the user(s) 110 of the system environment 100 may be a specialist, an employee or agent of a managing entity associated with the managing entity system 200, a member of an incident monitoring group, an auditor, a regulator, and the like.

The managing entity system 200, the incident monitoring system 300, the one or more computing device systems 400, the incident systems of record 120, the front line units 130, and/or the third party system 140 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet.

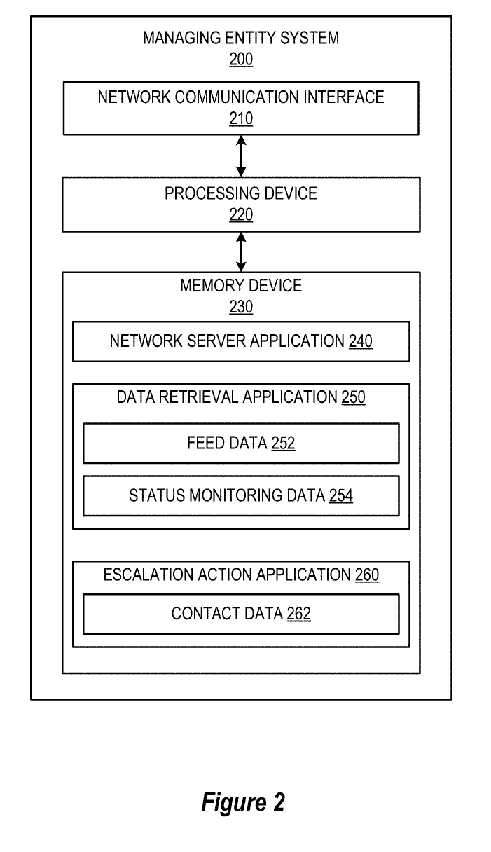

The managing entity system 200 may be a system owned or otherwise controlled by a managing entity to perform one or more process steps described herein. In some embodiments, the managing entity is a financial institution. In general, the managing entity system 200 is configured to communicate information or instructions with the incident monitoring system 300, the computing device system(s) 400, the incident systems of record 120, the front line units 130, and/or the third party system 140 across the network 150. For example, the managing entity system 200 may receive, from the plurality of front line units 130 and/or the incident systems of record 120, event data associated with the plurality of front line units 130. The managing entity system 200 may also be configured to interact with the incident monitoring system 300 to compare an incident with an affected front line unit 130 to data stored in the incident monitoring system 300. The managing entity system 200 may then be configured to communicate the triggering escalation action to one of the computing device systems 400 in the system environment 100 (e.g., to a computing device system 400 associated with the incident monitoring owner 112 and/or the computing device system 400 associated with the front line unit owner 114). For example, the managing entity system 200 may be configure to transmit control signals or other computer readable instructions to a computing device system 400, where the control signals are configured to cause a user interface of the computing device system 400 to display certain information in a particular format and/or request user input via the user interface of the computing device system 400. Of course, the managing entity system 200 may be configured to perform (or instruct other systems to perform) one or more other process steps described herein. The managing entity system 200 is described in more detail with respect to FIG. 2.

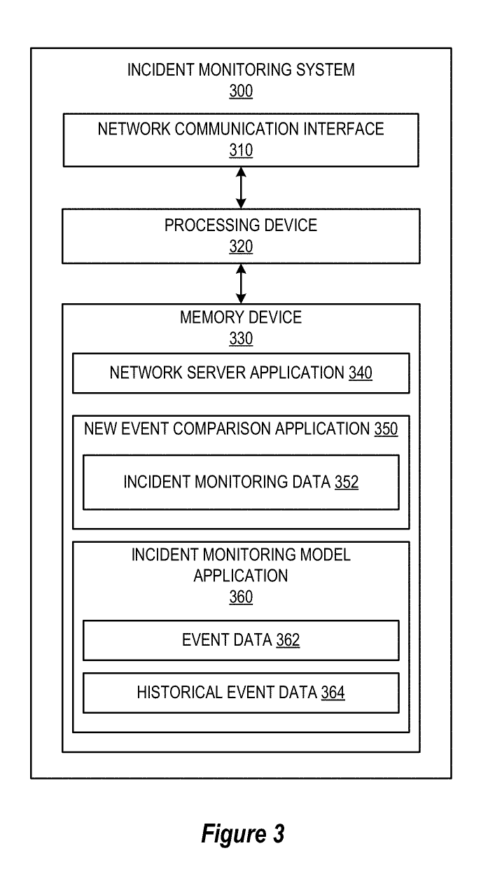

The incident monitoring system 300 may by a system owned or controlled by the managing entity, an enterprise process oversight group (e.g., a standalone organization or a business group of the managing entity), and/or a third party that specializes in receiving, storing, comparing, compiling, aggregating, distributing, and otherwise analyzing event data from front line units 130, escalation actions that are responses to incidents associated with the front line units 130, specialists or groups that are associated with the front line units 130, and/or incident monitoring models for displaying information associated with the event data. In general, the incident monitoring system 300 is configured to communicate information or instructions with the managing entity system 200, the computing device system(s) 400, the front line units 130, the incident systems of record 120, and/or the third party system 140 across the network 150. For example, the incident monitoring system 300 may receive instructions from the managing entity system 200 to perform certain comparisons of event data and other data stored within, or accessible by, the incident monitoring system 300, transmit matches, notification, alerts, and the like, to the other systems in the system environment 100, transmit a communication triggering action and/or an incident monitoring model to the computing device systems 400, and the like. Of course, the incident monitoring system 300 may be configured to perform (or instruct other systems to perform) one or more other process steps described herein. The incident monitoring system 300 is described in more detail with respect to FIG. 3.

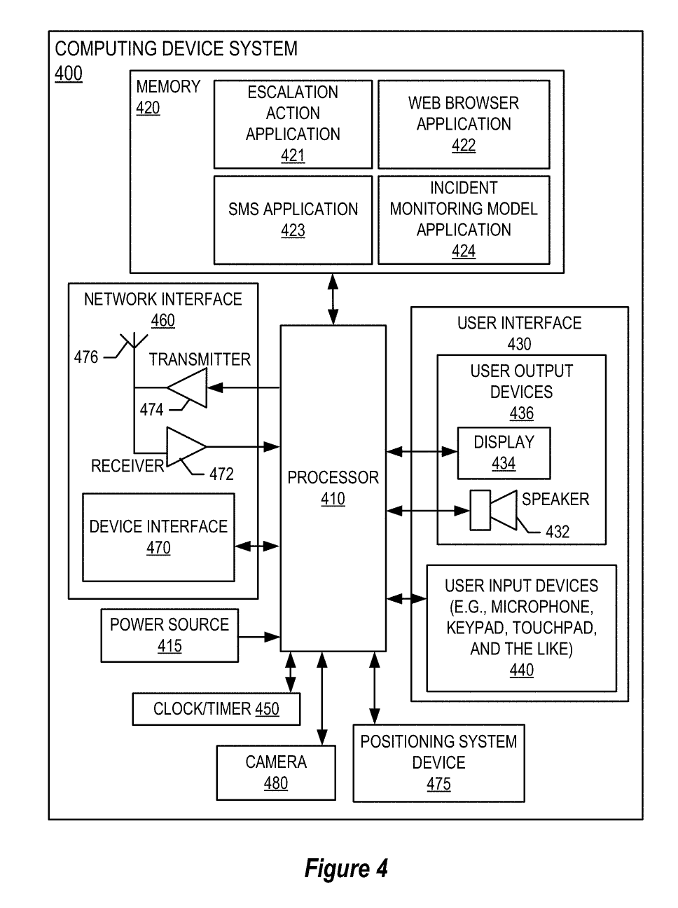

The computing device systems 400 may by one or more systems owned or controlled by the managing entity and/or a third party. In some embodiments, the computing device systems 400 may be owned or otherwise controlled by an individual user 110. In general, the computing device systems 400 are configured to communicate information or instructions with the managing entity system 200, the incident monitoring system 300, the front line units 130, the incident systems of record 120, and/or the third party system 140 across the network 150. For example, the computing device systems 400 may receive communication in the form of computer-readable instructions from the managing entity system 200 and/or the incident monitoring system 300 that cause a user interface of the computing device systems 400 to display certain triggering escalation actions, incident monitoring models, and the like. The computing device systems 400 may, in some embodiments, be configured to request and/or receive user input from one or more users 110. In response to receiving the user input, the computing device systems 400 may be configured to automatically transmit the user input to the managing entity system 200 and/or the incident monitoring system. Of course, the computing device systems 400 may be configured to perform (or instruct other systems to perform) one or more other process steps described herein. One embodiment of a computing device system 400 is described in more detail with respect to FIG. 4.

The front line units 130 illustrated in FIG. 1 represent the plurality of small-scale, individual business or process units that are distributed throughout an enterprise. While three front line units 130 are illustrated in FIG. 1 (i.e., Front Line Unit 1, Front Line Unit 2, and Front Line Unit 3), many more front line units 130 are contemplated and envisioned for the system environment 100. In some embodiments, the front line units 130 are geographically separated from each other. In some embodiments, two or more of the front line units 130 may overlap in some capacity.

As described in more detail below, the front line units 130 may be monitored, tracked, and/or otherwise analyzed by other components of the system environment 100 to determine when events associated with the front line units 130 have occurred. As used herein, the term “event” refers to an incident, problem, cause for concern, or the potential for one of the above (e.g., a trend in event data towards an incident), that has been detected by the front line unit, the incident systems of record 120, a user 110 (e.g., a front line unit owner 114), and the like. The detection of an event can be determined based on an analysis of “event data,” or information, reports, notifications, data trend reports, maintenance reports, customer surveys, employee surveys, public surveys, and the like.

The front line unit owner 114 may be one or more individual users 110 that are specially trained to manage, work with, monitor, instruct, or otherwise engage with one or more front line units 130. In some embodiments, a front line unit owner 114 is tasked with performing one or more escalation action steps to monitor, identify, fix, or otherwise mitigate an identified incident associated with a front line unit 130 associated with that front line unit owner 114.

The incident monitoring owner 112 may be one or more individual users 110 that are specially trained to manage, work with, monitor, instruct, or otherwise engage with two or more front line units 130. In particular, an incident monitoring owner 112 may be responsible for overseeing a set of front line units 130 that are related in some capacity (e.g., geographic region, line of business, likely incidents for those front line units 130, and the like). In some embodiments, an incident monitoring owner 112 is tasked with performing one or more escalation action steps to monitor, identify, fix, or otherwise mitigate one or more identified incidents associated with the one or more front line units 130 that are under the purview of the incident monitoring owner 112. The incident monitoring owner 112 may be an employee of the managing entity, a member of an enterprise process oversight group within the managing entity, an employee of a third party entity, or the like.

The incident systems of record 120 may be a special purpose computer configured to receive event data from each of the plurality of front line units 130, analyze the event data, detect trends in the analyzed event data, detect incidents, gaps, concerns, or the potential for one of the above, and the like. This analysis may occur in real-time, or in near real-time to identify incidents as soon as possible, giving the managing entity system 200 and the processes described herein as much time as possible to reconcile the incidents. As such, the incident systems of record 120 may comprise or otherwise communicate with a data mining tool, a data mining system, a data comparison device that utilizes machine learning algorithms, a data trawling system, or the like. At least a portion of the incident systems of record 120 may, in some embodiments, be a component of the managing entity system 200 and/or the incident monitoring system 300.

In some embodiments, the incident systems of record 120 is a component of a dedicated, secure link between the managing entity system 200 (or the incident monitoring system 300) and a plurality of servers associated with the front line units 130, such that the incident systems of record 120 can monitor the servers in real time, identify new events or incidents from the event data on those servers in real time, and transmit identified new events or incidents to the managing entity system 200 (or the incident monitoring system 300) in real time. In other embodiments, the incident systems of record 120 monitor the servers on a periodic basis (e.g., hourly, daily, weekly, and the like) to identify the new events or incidents from the event data on each of those servers. The incident systems of record 120 may also be triggered to monitor a particular server or set of servers in response to a request from a user (e.g., user 110), the managing entity system 200, the incident monitoring system 300, or the like.

In other embodiments, the incident systems of record 120 imports data feeds comprising the event data of each of the plurality of front line units 130, monitors the imported data, identifies any new events or incidents found in the imported data, and transmitting the new events or the incidents to the managing entity system 200 and/or the incident monitoring system 300 in real time or on a periodic basis (e.g., hourly, daily, weekly, and the like).

The third party system 140 may be any system that provides additional resources, information, regulatory or other compliance services, and the like. As with the other systems in the system environment 100, the third party system 140 may be configured to perform (or be instructed to perform) one or more of the process steps described herein.

FIG. 2 provides a block diagram illustrating the managing entity system 200, in greater detail, in accordance with embodiments of the invention. As illustrated in FIG. 2, in one embodiment of the invention, the managing entity system 200 includes one or more processing devices 220 operatively coupled to a network communication interface 210 and a memory device 230. In certain embodiments, the managing entity system 200 is operated by a first entity, such as a financial institution, while in other embodiments, the managing entity system 200 is operated by an entity other than a financial institution.

It should be understood that the memory device 230 may include one or more databases or other data structures/repositories. The memory device 230 also includes computer-executable program code that instructs the processing device 220 to operate the network communication interface 210 to perform certain communication functions of the managing entity system 200 described herein. For example, in one embodiment of the managing entity system 200, the memory device 230 includes, but is not limited to, a network server application 240, a data retrieval application 250 which includes feed data 252 and status monitoring data 254, an escalation action application 260 which includes contact data 262, and other computer-executable instructions or other data. The computer-executable program code of the network server application 240, the data retrieval application 250, and/or the escalation action application 260 may instruct the processing device 220 to perform certain logic, data-processing, and data-storing functions of the managing entity system 200 described herein, as well as communication functions of the managing entity system 200.

In one embodiment, the data retrieval application 250 includes feed data 252 and status monitoring data 254. The feed data 252 may comprise information about an imported data feed associated with front line units, a communication link to servers of front line units, and the like. In some embodiments, the feed data 252 may comprise actual event data from the front line units, along with historical event data for those front line units. The status monitoring data may include similar information about the data feeds and communication links to the front line units, along with information about current, historical, expected, and other status information. The “status” information may be information about a status of a front line unit, a status of an escalation action triggered by the process steps described below, and the like. In this way, the data retrieval application 250 is configured to cause the managing entity system 200 to perform certain process steps described herein that involve accessing, transmitting, communicating, monitoring, or otherwise retrieving and utilizing the event data used in the system environment 100.

Furthermore, the feed data 252 may include information, reports, notifications, data trend reports, maintenance reports, customer surveys, employee surveys, public surveys. This feed data 252 may further include incident keywords, thematic keywords, incident keyword tags, and the like. For example, a report received or extracted by the data retrieval application 250 may include a list of predetermined “themes” that are associated with a centralized concept that is related in some way to an incident, event, front line unit, line of business, or the like. For example, a report may include a tag to indicate that the identified incident is associated with a particular regulatory restriction. In embodiments where the data retrieval application actively searches remote databases, analyzes data feeds or other received and non-formatted (or low-formatted) data, the system may compare words and phrases in the data it is analyzing to determine whether any of the analyzed words or phrases match known incident keywords or phrases. For example, the system may be analyzing a non-formatted report (i.e., the report is not tagged with an incident keyword). The system can scan the report to identify a regulation citation that is also a known incident keyword. The data retrieval application 250 can then tag or otherwise link the incident, the event data associated with the incident, and the incident keyword to provide a thematic structure and depth to the event and incident data stored in or otherwise associated with the feed data 252.

Other examples of incident keywords include, but are not limited to, an underlying cause of the incident, a process that is affected by the incident, a process that is triggered by the occurrence of the incident, a line of business that is affected by the incident, and the like. Where incident keywords are described herein with respect to their relationship to incidents, it should be known that the incident keywords could additionally or alternatively be linked to affected front line units, individuals associated with the front line units or incidents, triggering escalation actions that are intended to mitigate or resolve incidents, and the like.

Multiple tags may be associated with any report or other received event data. Looking back to the regulatory restriction tag, the report could include a first tag indicating that the incident is associated with a particular regulatory body, a second tag indicating that the incident is associated with a particular act or policy of the regulatory body, a third tag indicating a specific regulation of the regulatory body and the particular act or policy, and a fourth tag indicating whether the incident is in compliance with the specific regulation.

In this way, each report, each extracted set of event data, and the like can be tagged, categorized, or otherwise filtered based on these incident keywords. Therefore, the feed data 252 may include a relational database that links the incident tags to their respective incidents (or other event data), as well as a relational database that links multiple, disparate incidents together based on a common theme, as ascertained by the commonality of one or more incident keywords, thematic keywords, and the like.

In one embodiment, the escalation action application 260 includes contact data 262. This contact data 262 may include information about which specialist (e.g., one or more individuals, groups, organizations, and the like) is associated with an identified escalation application that is being triggered within the system environment 100. For example, the contact data 262 may include phone numbers, email addresses, details about how to establish dedicated and secure communication channels with individuals, and the like. Additionally or alternatively, the contact data 262 may comprise information linking a specific escalation action, an identified incident, and/or an affected front line unit to a specialist. In this way, the escalation action application 260 is configured to identify appropriate specialists to contact, to establish communication links to those specialists, and/or to transmit communications (including triggered escalation actions) to the specialists.

The network server application 240, the data retrieval application 250, and/or the escalation action application 260 are configured to invoke or use the feed data 252, the status monitoring data 254, the contact data 262, other data accessible to the managing entity system 200, and the like when communicating through the network communication interface 210 with the incident monitoring system 300, the computing device systems 400, the incident systems of record 120, the front line units 130, and/or the third party system 140.

As used herein, a “communication interface” generally includes a modem, server, transceiver, and/or other device for communicating with other devices on a network, and/or a user interface for communicating with one or more customers. Referring again to FIG. 2, the network communication interface 210 is a communication interface having one or more communication devices configured to communicate with one or more other devices on the network 150, such as the incident monitoring system 300, the computing device systems 400, the incident systems of record 120, the front line units 130, the third party system 140, and the like. The processing device 220 is configured to use the network communication interface 210 to transmit and/or receive data and/or commands to and/or from the other devices connected to the network 150.

FIG. 3 provides a block diagram illustrating the incident monitoring system 300, in greater detail, in accordance with embodiments of the invention. As illustrated in FIG. 3, in one embodiment of the invention, the incident monitoring system 300 includes one or more processing devices 320 operatively coupled to a network communication interface 310 and a memory device 330. In certain embodiments, the incident monitoring system 300 is operated by a first entity, such as a financial institution, while in other embodiments, the incident monitoring system 300 is operated by an entity other than a financial institution. In some embodiments, at least a portion of the incident monitoring system 300 is a component of the managing entity system 200.

It should be understood that the memory device 330 may include one or more databases or other data structures/repositories. The memory device 330 also includes computer-executable program code that instructs the processing device 320 to operate the network communication interface 310 to perform certain communication functions of the incident monitoring system 300 described herein. For example, in one embodiment of the incident monitoring system 300, the memory device 330 includes, but is not limited to, a network server application 340, a new event comparison application 350 which includes incident monitoring data 352, an incident monitoring model application 360 which includes event data 362 and historical event data 364, and other computer-executable instructions or other data. The computer-executable program code of the network server application 340, the new event comparison application 350, and/or the incident monitoring model application 360 may instruct the processing device 320 to perform certain logic, data-processing, and data-storing functions of the incident monitoring system 300 described herein, as well as communication functions of the incident monitoring system 300.

In one embodiment, the new event comparison application 350 includes incident monitoring data 352. The incident monitoring data 352 within the new event comparison application 350 may comprise a database (e.g., a relational database) of known events, known incidents associated with certain events, severity information about a specific event or event type, a specific incident or incident type, or a specific front line unit or type of front line unit.

The incident monitoring data 352 may include links, tags, or other associations between incident keywords and events, incidents, affected front line units, triggering escalation actions. In this way, the incident monitoring data 352 can associate incidents, events, front line units, escalation actions, and the like to centralized, common themes that would otherwise not be represented in normal incident reports, event reports, and the like. For example, normal incident reporting comprises data and information related solely with the particular incident, front line unit, line of business, and the like, such that a specialist tasked with resolving the incident is able to address the single incident. However, by linking and consolidating incidents and events that take place across disparate systems into one centralized place, the incident keywords allow specialists and incident monitoring users to analyze, resolve, manage, and report incidents on a thematic level. By giving specialists and incident monitoring users a broader understanding of incidents and their underlying causes, affected processes, regulations, and the like, the system improves the ability of the specialists and incident monitoring users to correctly assess incidents across the enterprise. Furthermore, the specialists and incident monitoring users are able to look at the totality of the incidents across the enterprise, the totality or magnitude of the incidents associated with a common theme, and the like, in a way that is not available in normal incident reporting processes.

Furthermore, the incident monitoring data 352 may comprise ownership information about certain events, event types, incidents, incident types, front line units, front line unit types, escalation action steps, escalation action step types, and the like. In some embodiments, the incident monitoring data comprises escalation action steps that are paired with, configured to be responsive to, or otherwise associated with a specific combination of event data, identified incident from the event data, affected front line unit, associated specialist, identified severity level, identified priority level, or the like. In this way, the new event comparison application 350 is configured to receive new event data, compare that new event data to the data already stored in its database (e.g., the incident monitoring data 352) or other accessible data, identify a responsible specialist, and/or determine matches or close matches to identify one or more appropriate escalation action steps that can be implemented to address the new event.

In one embodiment, the incident monitoring model application 360 includes event data 362. This event data 362 may include the new event data that is being received, and/or other event data for events associated with front line units that are ongoing, incoming, and/or recently concluded. This event data may comprise time-line information about the event, affected front line units, responsible specialists, supervisors of the specialists, lines of business associated with the front line unit and/or the event, escalation action steps that are due, require prompt action, in progress, or been concluded, and the like. The event data may be updated in real time to provide the most up-to-date set of data for active events across the enterprise. The historical event data 364 of the incident monitoring model application 360 may include similar data for events that have already concluded, including, but not limited to, events that have concluded within a predetermined period of time (e.g., in the last month). This historical event data can provide important insights into trends of the event data across a single front line unit over time, across a plurality of front line units over a period of time, across a particular line of business or geographical region associated with the front line units, and the like.

As such, the incident monitoring model application 360 has useful resources from which it can compile, generate, or otherwise build certain incident monitoring models that can be presented to certain users throughout the enterprise. For example, these models can be presented to an owner of a single front line unit, to an owner of an incident monitoring unit that monitors multiple front line units, and/or to an executive or other enterprise-wide employee of the managing entity to provide varied levels of information about the individual front line units, regional or thematic groups of individual front line units, and/or all front line units across the enterprise.

One example of an incident monitoring model is a chart of an identified new event and other current and/or historical events, as compared to status and time to completion information for each escalation action step associated with each event. This will allow a specialist to visualize the health and welfare of one or more front line units within an enterprise, and allow the specialist to reallocate resources where necessary to address any problematic areas. A similar incident monitoring model compares the event data to ownership information, which will allow a specialist to identify areas and departments where resources can be reallocated.

In some embodiments, the incident monitoring model may compare the event data 362 to severity levels for each escalation action step, incidents, and/or individual front line unit. This embodiment allows a specialist viewing the model to identify areas where resources can be allocated to address the more-severe areas with a higher priority. In some embodiments, trends from the historical event data 364 may be presented and compared to present states of front line units, incidents, and/or escalation action steps across the enterprise. In this way, the specialist can view trends over time for individual front line units, geographic regions of front line units, lines of business associated with front line units, owners of front line units, and the enterprise overall to identify any underlying incidents and/or potential future incidents at an earlier point in time than without the trend analysis and visual presentation.

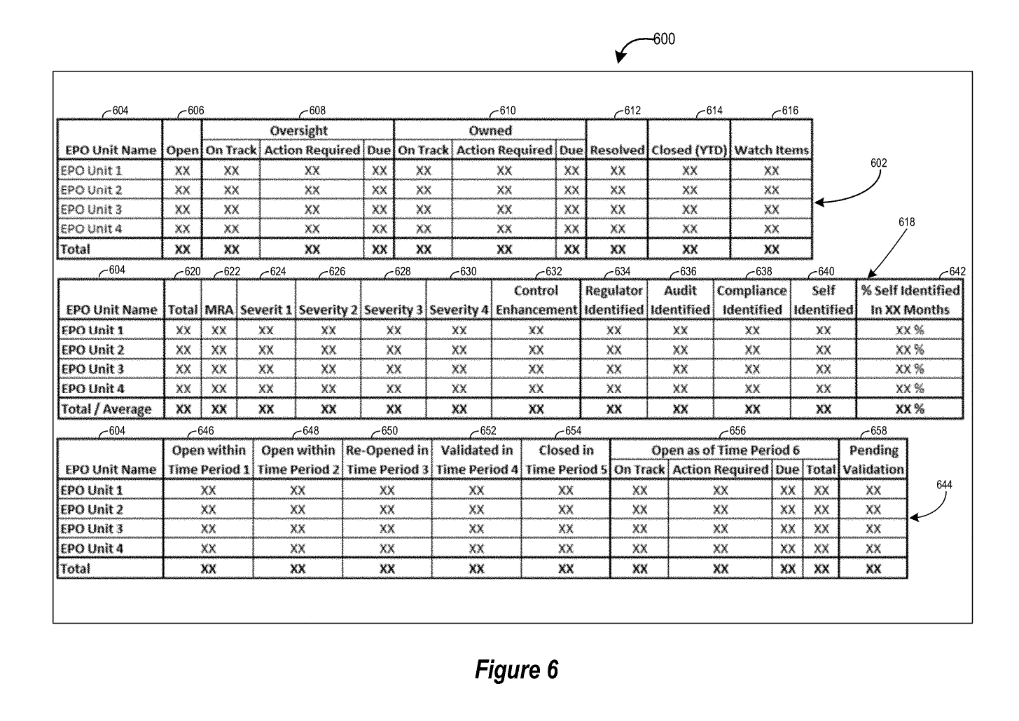

In some embodiments, the model can be compiled and presented as a chart. In some embodiments, the model is presented as a map across at least a region of the enterprise with status information, ownership information, severity information, and trend information being presented in a visual format (e.g., with icons, color coding, heat mapping, color intensity mapping, nodal size adjustment, and the like). The information in the model can be filtered by a viewer (e.g., a specialist), such that the viewer is able to visualize only the information that the viewer desires to analyze. Additional considerations and representations of the incident monitoring models that can be produced using the incident monitoring model application 360 are provided with respect to FIGS. 6-9.

The network server application 340, the new event comparison application 350, and the incident monitoring model application 360 are configured to invoke or use the incident monitoring data 352, the event data 362, the historical event data 364, and the like when communicating through the network communication interface 310 with the managing entity system 200, the one or more computing device systems 400, the front line units 130, the incident systems of record 120, and/or the third party system 140.

As used herein, a “communication interface” generally includes a modem, server, transceiver, and/or other device for communicating with other devices on a network, and/or a user interface for communicating with one or more customers. Referring again to FIG. 3, the network communication interface 310 is a communication interface having one or more communication devices configured to communicate with one or more other devices on the network 150, such as the managing entity system 200, the one or more computing device systems 400, the front line units 130, the incident systems of record 120, the third party system 140, and the like. The processing device 320 is configured to use the network communication interface 310 to transmit and/or receive data and/or commands to and/or from the other devices connected to the network 150.

FIG. 4 provides a block diagram illustrating a computing device system 400 of FIG. 1 in more detail, in accordance with embodiments of the invention. The computing device system 400 may comprise one or more personal computers, mobile devices, workstations, and the like. In one embodiment of the invention, the computing device system 400 is a mobile telephone. However, it should be understood that a mobile telephone is merely illustrative of one type of computing device system 400 that may benefit from, employ, or otherwise be involved with embodiments of the present invention and, therefore, should not be taken to limit the scope of embodiments of the present invention. Other types of computing devices may include portable digital assistants (PDAs), pagers, mobile televisions, gaming devices, laptop computers, cameras, video recorders, audio/video player, radio, GPS devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like. For example, the computing device system 400 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 4GPP protocols and/or the like. The computing device system 400 may also be configured to operate in accordance with non-cellular communication mechanisms, such as via a wireless local area network (WLAN) or other communication/data networks.

As described above, the computing device system 400 has a user interface 430 that is, like other user interfaces described herein, made up of user output devices 436 and/or user input devices 440. The user output devices 436 include a display 434 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface 430 may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices. The positioning system device 475 may play a crucial role in transmitting location information associated with the computing device system 400 for determining when the computing device system 400 is in, at, or is in close proximity to a front line unit or a geographic area associated with the front line unit.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, an application 421, an SMS application 423, an incident monitoring model application 424, or any other application provided by the managing entity system 200. These applications also typically provide instructions to a graphical user interface (GUI) on the display 434 that allows the user 110 to interact with the managing entity system 200, the incident monitoring system 300, and/or other devices or systems. In one embodiment of the invention, the user 110 downloads, is assigned, or otherwise obtains the escalation action application 421 and/or the incident monitoring model application 424 from the managing entity system 200, or from a distinct application server (e.g., from the incident monitoring system 300). In other embodiments of the invention, the user 110 interacts with the managing entity system 200 or the incident monitoring system 300 via the web browser application 422 in addition to, or instead of, the escalation action application 421 and/or the incident monitoring model application 424.

As mentioned above, the memory 420 may include the escalation action application 421. The escalation action application 421 may be configured to receive instructions from the managing entity system 200 and/or the incident monitoring system 300 that activate the escalation action application 421, thereby causing the escalation action application 421 to cause the display 434 to provide certain information about a triggered escalation action, to monitor a progress of the escalation action, to receive user input from the user input devices 440, and to communicate the user input back to the managing entity system 200 and/or the incident monitoring system 300.

Additionally or alternatively, the memory 420 may include the incident monitoring model application 424. The incident monitoring model application 424 may be configured to receive instructions from the managing entity system 200 and/or the incident monitoring system 300 that activate the incident monitoring model application 424, thereby causing the incident monitoring model application 424 to cause the display 434 to provide certain information about an incident monitoring model, to continuously update the displayed incident monitoring model, to receive user input from the user input devices 440, and to communicate the user input back to the managing entity system 200 and/or the incident monitoring system 300.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

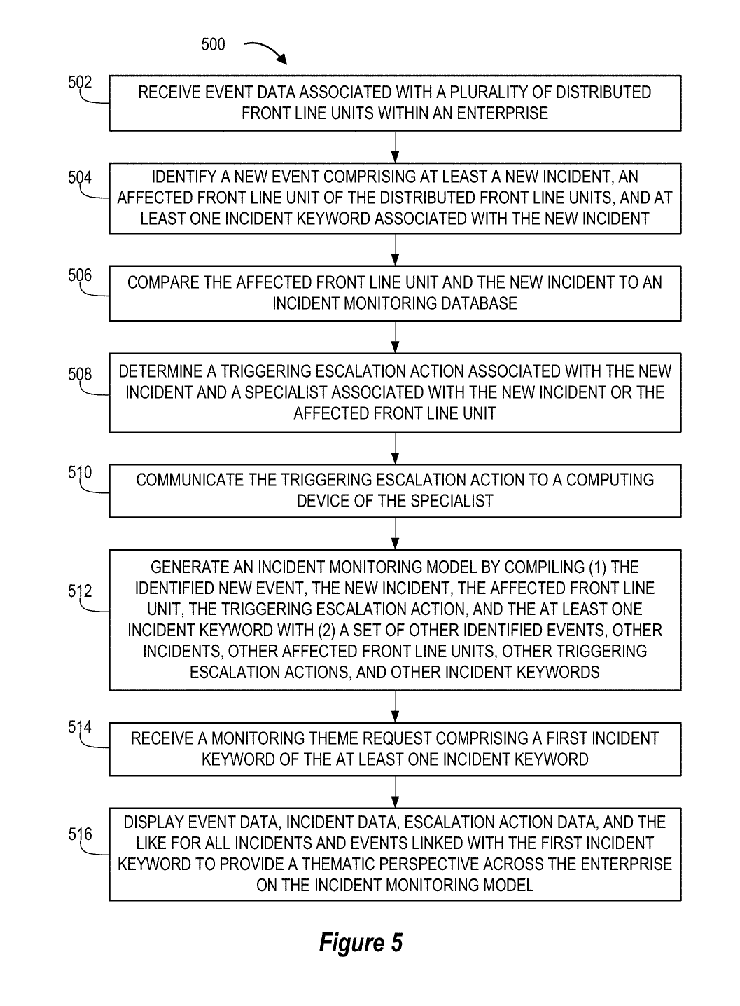

Referring now to FIG. 5, a flowchart is provided to illustrate one embodiment of a process 500 for triggering enterprise-wide actions in response to detecting events from distributed front line units, in accordance with embodiments of the invention. One or more of the steps for this process 500 described herein may be automated by computing technology to expedite the process, to reduce the overall burden of resources on non-specialized computing systems, and the like.

In some embodiments, the process 500 may include block 502, where the system receives event data associated with a plurality of distributed front line units within an enterprise. As described above, and as used herein, the term “event” may refer to an incident, incident, concern, warning, transaction, financial transaction, regulatory or compliance incident, and the like that occurs at or otherwise affects one or more front line units.

As such, the “event data” may be any information associated with an event itself, the front line unit(s) affected by an event, regulations or compliance procedures associated with an event, messages associated with the event, geographic locations of an event, lines of business associated with an event, individuals or business groups associated with the event (e.g., responsible for the event, affected by the event, responsible for responding to the event, and the like), time information about the event (e.g., time of the event, a time the event was detected, and the like), an event identifier (e.g., an identity of an individual that identified and/or reported the event, a computer application that automatically identified the event, and the like), an event type, or any other data that can be used to trigger the triggering escalation actions and/or incident monitoring models described herein.

Furthermore, the term “front line unit” may refer to an individual business group, an individual physical location of a business group, a server location for a line of business or of a business process, and the like. In some embodiments, a plurality of front line units are distributed across an enterprise that may cover a large geographical region, including across the world. As such, the individual front line units may be disparate, separate, or otherwise at least partially independent of one another throughout the enterprise. For example, two front line units that are associated with different business processes may be managed by different individuals, in different departments within the overall managing entity's business structure.

Therefore, the system may be configured to carry out this step to monitor or otherwise receive event data from each of the plurality of distributed front line units across the enterprise. The system may receive the event data in real time, in near real time, periodically in batches, only when a severe or high priority new event is detected, or the like. However, it is beneficial for the system to receive the event data in real time to expedite the other processes steps described below and to resolve any incidents associated with an event as soon as possible to benefit the health and welfare of the affected front line unit, the regional enterprise units, and the overall enterprise.

To achieve a prompt reception of the event data, the system may involve establishing secure dedicated communication links to servers of each of the plurality of front line units and monitoring the servers of each of the plurality of front line units to identify the event data in real time or periodically. In some embodiments, these secure dedicated communication links are used solely for the purpose of receiving event data and to feed the system with the event data for faster processing.

Additionally or alternatively, receiving the event data may involve or comprise importing data feeds comprising the event data from each of the plurality of distributed front line units within the enterprise and monitoring the imported data feeds for the new event in real time or periodically. In this way, the system can receive event data in real time or periodically, store the received event data on a local or accessible database, track the event data over time, and the like, through its data feed.

The portion of the system configured to receive the event data may include or comprise an incident system of record, a data mining tool, data mining system, or the like, that is configured to review the received data, to trawl certain databases, websites, social media portals, emails, and the like, to identify event data from those sources, and to transmit the event data back to the managing entity system.

In some embodiments, the process 500 includes block 504, where the system identifies a new event comprising at least a new incident, an affected front line unit of the distributed front line units, and at least one incident keyword associated with the new incident. As used herein, the term “new event” may refer to an event that has recently started occurring, that has recently been identified as occurring, that may be predicted to occur in the future, or the like. The new event may be an occurrence, execution, process, or other happening that causes the new event to take place.

The new event may be identified in several ways. For example, a user associated with the new event (e.g., an employee positioned at a front line unit affected by the new event, or an employee reviewing a status of the affected front line unit) may transmit a report or notification (e.g., from a computing device of that user) to the system. In some embodiments, the system identifies the new event from the received or otherwise acquired event data for the plurality of front line units across the enterprise. For example, the new event may be identified simply as newly received event data.

In other embodiments, the system makes a determination that certain received or otherwise acquired data does in fact point to a new event. For example, the system may use incident systems of record and/or a data mining tool to identify keywords, predetermined codes, and the like within the even data (e.g., from a data feed, or from the data identified by the incident systems of record or data mining tool through trawling), where these keywords or codes are associated with the occurrence or likely future occurrence of an event. As the incident systems of record and/or the data mining tool identifies a new event, the incident systems of record can collect all potentially related data and transmit the collected data to the managing entity system. For example, the incident systems of record may identify a start time (or proximate start time) of the new event, a time that the new event was identified, one or more incidents associated with the new event, information about the front line unit associated with the new event, information about individual users or employees associated with the affected front line unit and/or the incident, a geographic location of the event, a line of business associated with the event, and the like.

As such, the system may be able to identify, from the event data, the new event and the information associated with this new event including, but not limited to the affected front line unit and the incident associated with the event.

As mentioned above, the event data may be parsed, analyzed, extracted, or otherwise reviewed to identify one or more incident keywords. These incident keywords are terms, words, phrases, codes, images, regulation names, regulation reference codes, and the like. The incident keywords may be tagged (e.g., automatically by the system or manually by an individual reporting the incident) to link the event data, including the incident, the affected line of business, and the like, to the incident keyword.

For example, a report received or extracted by the data retrieval application 250 may include a list of predetermined “themes” that are associated with a centralized concept that is related in some way to an incident, event, front line unit, line of business, or the like. For example, a report may include a tag to indicate that the identified incident is associated with a particular regulatory restriction.

In embodiments where the data retrieval application actively searches remote databases, analyzes data feeds or other received and non-formatted (or low-formatted) data, the system may compare words and phrases in the data it is analyzing to determine whether any of the analyzed words or phrases match known incident keywords or phrases. For example, the system may be analyzing a non-formatted report (i.e., the report is not tagged with an incident keyword). The system can scan the report to identify a regulation citation that is also a known incident keyword. The data retrieval application 250 can then tag or otherwise link the incident, the event data associated with the incident, and the incident keyword to provide a thematic structure and depth to the event and incident data stored in or otherwise associated with the feed data 252.

Other examples of incident keywords include, but are not limited to, an underlying cause of the incident, a process that is affected by the incident, a process that is triggered by the occurrence of the incident, a line of business that is affected by the incident, and the like. Where incident keywords are described herein with respect to their relationship to incidents, it should be known that the incident keywords could additionally or alternatively be linked to affected front line units, individuals associated with the front line units or incidents, triggering escalation actions that are intended to mitigate or resolve incidents, and the like.

Additionally, in some embodiments, the process 500 includes block 506, where the system compares the affected front line unit and the new incident to an incident monitoring database. As used herein, the incident monitoring database may comprise one or more relational databases that link or associate the event data with stored triggering escalation actions. As used herein, the term “escalation action” may refer to any action step, set of action steps, and the like that can be implemented to resolve or otherwise mitigate an identified incident at an affected front line unit. Escalation actions, or action steps, may be any executable by a specialist, or a step that is capable of being monitored by the specialist. In some embodiments, the escalation action may comprise instructions to refrain or stop some activity. In other embodiments, the escalation action may be instructions to start or continue some activity.

As mentioned above, the incident monitoring system and/or database may link or otherwise pair certain combinations of incidents, incident types, front line units, front line unit types, lines of business associated with events, time-based information associated with events, compliance regulations and/or internal compliance standards associated with events, and the like, to certain responsive escalation actions and/or specialists tasked with carrying out the escalation actions once the actions are triggered.

Therefore, once the system has identified at least an incident and an affected front line unit, the system can identify which triggering escalation action matches the identified combination of event data. In some embodiments, the system may not find a perfect match within the incident monitoring database. In such cases, the system may transmit a request to a computing device for an escalation action expert for user input regarding which triggering escalation action step(s) are necessary, based on the known or identified event data. The escalation action expert can input the correct triggering action steps and the computing device of that expert will transmit the user input back to the system, providing the correct triggering escalation action information.

Similarly, in some embodiments, the system may identify more than one set of escalation action steps based on the received or identified new event data. In such embodiments, the system can request user input from the expert in escalation actions comprising an ideal or preferable set of escalation action steps, which can then be used for the subsequent portions of this process 500.

Additionally, the incident monitoring database may link or otherwise pair the one or more incident keyword to the rest of the event data. In this way, the system is able to create a relational database that can later be utilized to extract all information associated with a common theme by pulling all information tagged with a particular incident keyword.

The process 500 may also include block 508, where the system determines a triggering escalation action associated with the new incident and a specialist associated with the new incident or the affected front line unit. Through the comparison steps described above (or from the request of information from an expert in escalation action steps), the system is able to determine the correct, preferable, or ideal escalation action that should be triggered in response to the identified incident and affected front line unit of the new event. As mentioned above, an escalation action may comprise multiple action steps that may be executable in any order or in a specific order, based on instructions associated with the action steps. For example, the triggering escalation action may comprise three action steps: a first action step to end a certain process that is associated with or otherwise perpetuates the identified incident, a second action step to design a new process configured to replace the certain process associated with the incident, and a third action step to start or otherwise implement the new process at the front line unit as a working replacement to the certain process.

As used herein, the term “specialist” refers to an individual or group of individuals with particular, specialized training in implementing escalation actions as the actions are triggered. In some embodiments, a specialist is an owner or manager of the affected front line unit. In other embodiments, the specialist is an owner or manager of an incident monitoring group that is tasked with overseeing multiple front line units across the enterprise.

Of course, in some embodiments, the system is receiving event data associated with many front line units across an enterprise, and some identified incidents require more-prompt response times, more specialized responses, more resources, and the like than other identified incidents. To accommodate the varied priorities across the entire enterprise, in some embodiments, the system may determine a priority ranking of the determined triggering escalation action. The system may also determine that the priority ranking of the determined triggering escalation action is below a priority ranking of a different triggering escalation action. As described with respect to block 510, the system can then know to prioritize the higher-priority ranked escalation action by requesting or requiring the lower-priority ranked escalation action to delay the implementation of its action unless or until the higher-priority ranked escalation action is complete.

In some embodiments, the process 500 includes block 510, where the system communicates the triggering escalation action to a computing device of the specialist. The computing device of the specialist may comprise some or all of the components described with respect to the computing device system 400 of FIG. 4. As such, the system may transmit control signals, computer readable instructions, or the like to initiate an application stored on the computing device of the specialist, thereby causing the computing device of the specialist to activate the display of the computing device to present the triggering escalation action such that the specialist may view the escalation action. In some embodiments, the computing device of the specialist is further instructed to provide a request for user input via the display. In such embodiments, the system may receive the user input via user input devices and automatically transmit the user input to the managing entity system.

For example, the system may be configured to cause the computing device of the specialist to display a request for user input indicating at least a portion of the escalation action has been completed. Once the specialist has completed the escalation action, the specialist may key in the response using the user interface of the computing device of the specialist. This response is then transmitted to the managing entity system, which can then update the status of the incident and/or the affected front line unit based on the user input from the specialist.

In embodiments where the determined triggering escalation action has a priority ranking below a priority ranking of a different triggering escalation action, the system may adjust the communication of the triggering escalation action to include or comprise instructions to defer execution of the triggering escalation action until the different (higher priority) triggering escalation action is fully executed.

Additionally, in some embodiments, the process 500 includes block 512, where the system generates an incident monitoring model by compiling (1) the identified new event, the new incident, the affected front line unit, the triggering escalation action, and the at least one incident keyword with (2) a set of other identified events, other incidents, other front line units, other triggering escalation actions, and incident keywords. This incident monitoring model allows specialists, managers, compliance employees, regulators, officers, incident monitoring units, and the like to visualize the health of the enterprise from as narrow a level as a single front line unit to as broad a level as all front line units within the entire enterprise.

For example, a specialist or manager viewing the incident monitoring model may be able to view the health of a specific grouping of front line units (e.g., grouped based on geographic location, line of business, or the like) to visualize potentially macro incidents that are not necessarily picked up on an individual front line unit level.

In some embodiments, the enterprise oversight model comprises a chart of the identified new event and the set of other identified events, as compared to status and time to completion information. The enterprise oversight model may also comprise a chart of the identified new event and the set of other identified events, as compared to ownership information. Furthermore, the incident monitoring model may comprise a chart of the identified new event and the set of other identified events, as compared to severity information.

In some embodiments, the incident monitoring model may comprise a chart of the identified new event and the set of other identified events, as compared to event data trends for the plurality of front line units within the enterprise. Some embodiments of the incident monitoring model involve the display of a map denoting status information for the identified new event and each of the set of other identified events across the enterprise. As such, each front line unit, or each grouping of front line units, can be represented as a node on the map with severity, time, and/or escalation action status information being represented in symbols, colors, or other indicia over the map. A monitoring user may be able to adjust the view of the map by adjusting which types of information is represented through the use of color-coded or symbol layers over the base display of the map. Of course, other embodiments of the incident monitoring model are contemplated herein, and some examples of an incident monitoring model are illustrated in FIGS. 6-9 of this application.

The process 500 may then include block 514, where the system receives a monitoring theme request comprising a first incident keyword of the at least one incident keyword (i.e., one of the incident keywords associated with the new incident). The monitoring theme request may be received from a computing device of a user (e.g., an incident monitoring user) that is tasked with monitoring, analyzing, reviewing, or otherwise interested in receiving a thematic representation of incidents, event data, and the like across an entire enterprise.

In some embodiments, the user may select multiple incident keywords and provide an indication as to whether the user would like to visualize all incident data associated with all selected incident keywords or all incident data associated with at least one incident keyword. In this way, the system allows the user to filter incident data to only receive incident data associated with a theme of interest to the user.

While not represented in the process 500, the system may analyze incident data associated with each incident keyword, compare this incident data associated with each incident keyword to historical incident data for each incident keyword, and identify the first incident keyword as being associated with a high variance in the number of incidents, severity of incidents, location of incidents, and the like in the current incident data versus the historical incident data. In this way, the system can aid the user by identifying a troubled incident keyword that can be analyzed by the user to better understand the incidents across the common theme of the troubled incident keyword.

Finally, the process 500 may include block 516, where the system displays event data, incident data, escalation action data, and the like for all incidents and events linked with the first incident keyword to provide a thematic perspective across the enterprise on the incident monitoring model. As mentioned above, the user is able to select one or more incident keywords to filter the overall incident data within the incident monitoring model to present only the incident data associated with a common theme of the selected incident keywords.

By displaying only the incident data associated with a common theme, the incident monitoring model is able to provide a view of the totality of the incidents associated with a common theme. For example, if the user selects or otherwise inputs the incident keyword associated with a particular regulation, the incident monitoring model will display all incident data associated with that incident keyword for the particular regulation so the user can view only the incident data associated with the particular regulation. This allows the user to get a better understanding of the totality or magnitude of the incidents that are affected by and/or that affect the common theme (e.g., the regulation) than would be possible in normal incident reporting processes that are directed to providing data only for that individual incident. Again, the linkage of the incident keywords to the incident and event data as they are received and/or stored in the incident monitoring database allows the system to automatically consolidate its displayed data to that data that is associated with the particular incident keyword.

In some embodiments, the system may monitor a status of the new event or of the determined triggering escalation action. As mentioned above, this monitoring step may comprise requesting user input from the specialist to indicate when the escalation action has completed. In other embodiments, the system may actively track data associated with the affected front line unit, the incident, and/or the specialist to identify when at least a portion of the escalation action has completed. For example, the system may use similar mechanics to those described with respect to blocks 502 and 504 when monitoring the status of the new event, including the use of incident systems of record or a data mining tool to trawl, analyze, and otherwise identify data that would indicate a change in the status of the new event.

In some such embodiments, when the status of the new event is normal, or when the status of the triggering escalation action is complete, the system updates the incident monitoring model and communicates a conclusion notification for the triggering escalation action to the computing device of the specialist. Of course, in some embodiments, the escalation action is comprised of multiple steps, and the system may update the incident monitoring model in response to determining that a single step or portion of the escalation action has concluded.

In this way, the system can provide an up-to-date and real time visualization of the overall health and welfare of the individual front line units, groupings of individual front line units, and the overall enterprise through a single incident monitoring model.

FIGS. 6-9 provide illustrations of sample displays 600, 700, 800, and 900 of possible embodiments the incident monitoring model described herein. As mentioned above, the incident monitoring tool allows a user to filter the incident data by one or more incident keywords to cause the incident monitoring model to display only the incident data tagged with or linked to the selected incident keywords. This allows a user to view the incident data across disparate systems in the enterprise that are related by a common underlying cause of the incident, a common regulation requirement, a common business process, and the like. Therefore, for each of the sample displays 600, 700, 800, and 900 described herein, it should be known that the displayed incident data may be filtered such that only incident data associated with a common theme is included in the tables, charts, reports, maps, and other displays of the incident monitoring model.

FIG. 6 illustrates one embodiment of a display 600 of the incident monitoring model comprising an incident monitoring level (i.e., a grouping of individual front line units) design and view. First, a condition and ownership view 602 is provided, the condition and ownership view 602 comprising columns for how many incidents are open 606, how many incidents are under oversight 608, how many incidents are currently owned 610, how many incidents have been resolved 612, how many incidents have been closed within the past year 614, and how many incidents are currently watch items 616 for each listed enterprise process oversight (EPO) unit 604. As used herein, an “EPO unit” refers to an incident management group that oversees incidents occurring at or otherwise associated with two or more front line units. As such, incidents, and the data associated with the incidents, for each front line unit associated with an EPO unit 604 is considered data associated with the EPO unit 604. The oversight 608 and owned 610 columns are further broken down to which EPO units have incidents that are on track, require action now, or are due/past due.

Next, a severity and identification view 618 is provided, the severity and identification view 618 comprising columns for how many incidents have been identified in total 620, how many incidents (or matters) require attention 622, how many incidents are associated with severity levels of Severity 1 624, Severity 2 626, Severity 3 628, Severity 4 630, and how many incidents require control enhancement 632 for each incident associated with each EPO unit 604 name. Furthermore, the severity and identification view 618 includes columns for how many incidents were identified by a regulator 634, how many incidents were identified from an audit 636, how many incidents were identified through compliance checks 638, how many incidents were self-identified 640 by an individual responsible for the incident, and a percentage of the number of incidents that were self-identified within a predetermined period of time 642 (e.g., over a period of several months, over the past year, and the like) for each of the listed EPO unit 604 names.

Finally, an inventory movement view 644 is provided, comprising columns to provide a number of incidents opened within a first predetermined period of time 646, a number of incidents opened within a second predetermined period of time 648, a number of incidents re-opened within a third predetermined period of time 650, a number of incidents validated within a fourth predetermined period of time 652, a number of incidents closed within a fifth predetermined period of time 624, a number of incidents open as of a certain period of time 656 (e.g., currently open incidents, incidents open as of the beginning of the month, and the like), and a number of incidents that are pending validation 658 for each of the listed EPO unit 604 names. While several different predetermined time periods are listed, it should be known that two or more of these predetermined time periods may be the same time period. The column listing the number of incidents associated with each listed EPO unit 604 name may be broken down to list the number of incidents that are on track, that require action, that are due or past due, and the total number of open incidents.

In some embodiments, the inventory movement view 644 includes additional columns for the number of incidents that have upcoming resolution dates within a plurality of predetermined dates for each of the listed EPO unit 604 names (e.g., within the next month, within the next two months, resolution dates to be determined, and the like).

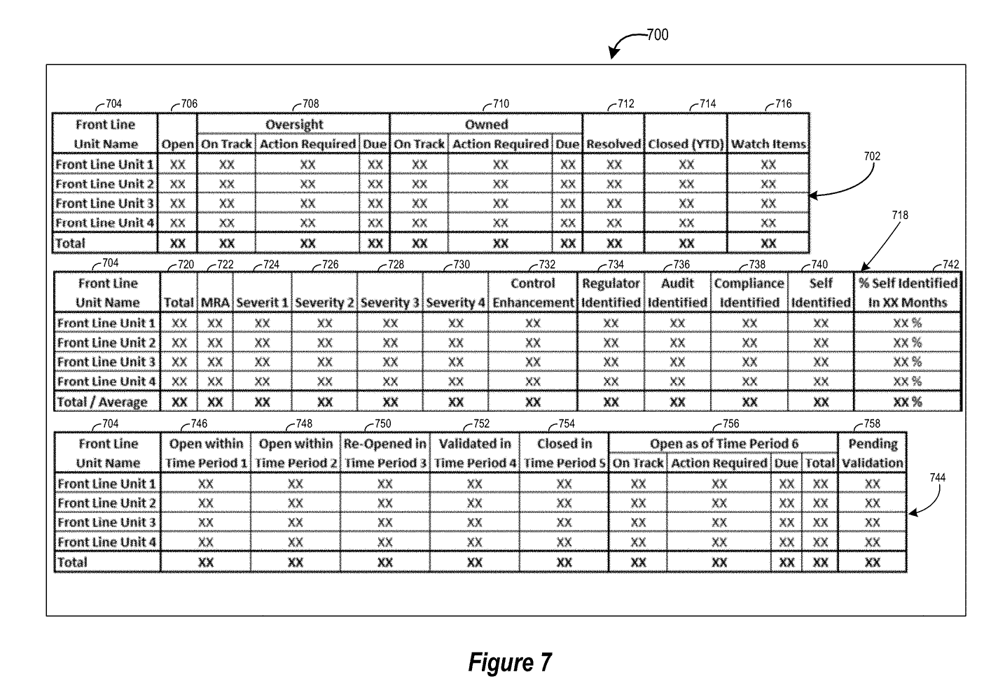

FIG. 7 illustrates one embodiment of a display 700 of the incident monitoring model comprising a front line unit level (i.e., individual front line units) design and view.

First, a condition and ownership view 702 is provided, the condition and ownership view 702 comprising columns for how many incidents are open 706, how many incidents are under oversight 708, how many incidents are currently owned 710, how many incidents have been resolved 712, how many incidents have been closed within the past year 714, and how many incidents are currently watch items 716 for each listed front line unit name 704. The oversight 708 and owned 710 columns are further broken down to which front line units have incidents that are on track, require action now, or are due/past due.

Next, a severity and identification view 718 is provided, the severity and identification view 718 comprising columns for how many incidents have been identified in total 720, how many incidents (or matters) require attention 722, how many incidents are associated with severity levels of Severity 1 724, Severity 2 726, Severity 3 728, Severity 4 730, and how many incidents require control enhancement 732 for each incident associated with each front line unit name 704. Furthermore, the severity and identification view 718 includes columns for how many incidents were identified by a regulator 734, how many incidents were identified from an audit 736, how many incidents were identified through compliance checks 738, how many incidents were self-identified 740 by an individual responsible for the incident, and a percentage of the number of incidents that were self-identified within a predetermined period of time 742 (e.g., over a period of several months, over the past year, and the like) for each of the listed front line unit names 704.

Finally, an inventory movement view 744 is provided, comprising columns to provide a number of incidents opened within a first predetermined period of time 746, a number of incidents opened within a second predetermined period of time 748, a number of incidents re-opened within a third predetermined period of time 750, a number of incidents validated within a fourth predetermined period of time 752, a number of incidents closed within a fifth predetermined period of time 724, a number of incidents open as of a certain period of time 756 (e.g., currently open incidents, incidents open as of the beginning of the month, and the like), and a number of incidents that are pending validation 758 for each of the listed front line unit names 704. While several different predetermined time periods are listed, it should be known that two or more of these predetermined time periods may be the same time period. The column listing the number of incidents associated with each listed front line unit name 704 may be broken down to list the number of incidents that are on track, that require action, that are due or past due, and the total number of open incidents.

In some embodiments, the inventory movement view 744 includes additional columns for the number of incidents that have upcoming resolution dates within a plurality of predetermined dates for each of the listed front line unit names 704 (e.g., within the next month, within the next two months, resolution dates to be determined, and the like).

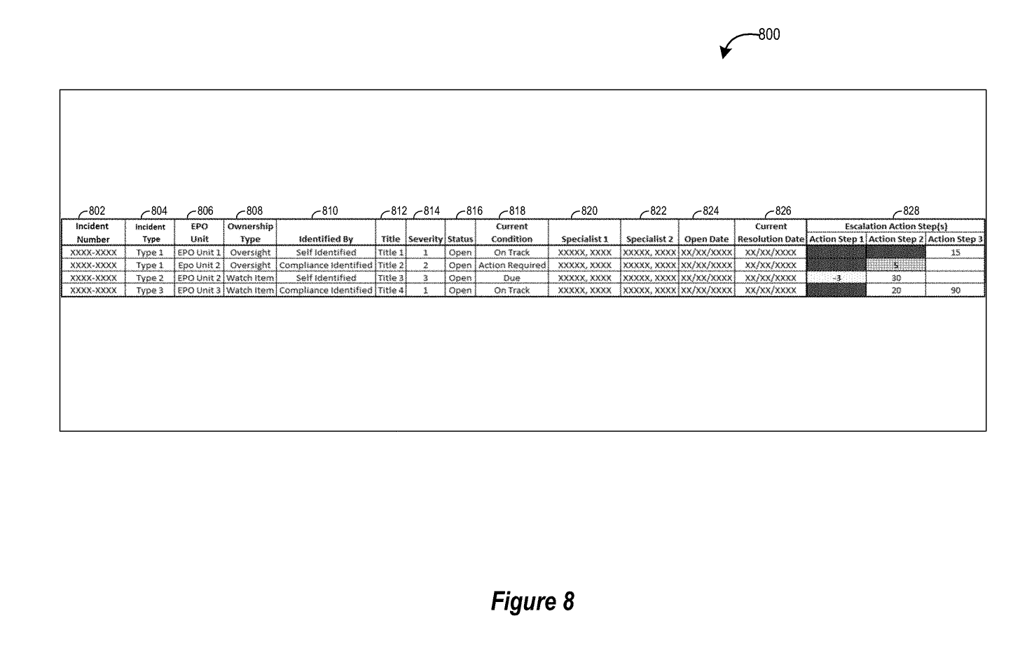

FIG. 8 illustrates on embodiment of a sample display 800 for providing a listing of the incidents and related information to these incidents to enable a specialist or manager to identify where and when to allocate resources to resolve or otherwise mitigate the incident. As shown in FIG. 8, each incident list is given an incident number to identify it. The incident number is presented in the incident number column 802. The display 800 may further include an incident type 804. Next, the display 800 may provide an EPO unit column 806 to provide an EPO unit associated with each incident. As an EPO unit is tasked with monitoring, controlling, or otherwise overseeing a plurality of front line units, there may be multiple incidents associated with each EPO unit, and therefore the EPO units may be repeated in the display 800 under the EPO unit column 806.

The system may further provide an ownership type column 808 that describes what type of ownership is currently tasked to each of the listed incident numbers. For example, the ownership type may be “oversight,” “watch item,” “owned,” or the like. Next, the display 800 may include an identified by column 810 that lists the type of identification that led to the detection of each specific incident. Examples of the types of identification include “self-identified,” compliance identified,” “audit identified,” “regulator identified,” and the like.

The display 800 may also give a title to each of the identified incidents in the title column 812. Importantly, the display 800 may include a severity level for each of the identified incidents in the severity column 814. The status column 816 may provide a status (e.g., “open,” “closed,” “awaiting regulatory approval,” and the like) for each of the identified incidents. The current condition column 818 may denote whether each of the identified incidents are “on track,” require action (i.e., “action required”), or are past due (i.e., “due”). In some embodiments, the current condition column 818 may be color coded to enable easy visual analysis of the status of each incident within the display 800.

In some embodiments, the display 800 includes a specialist 1 column 820 that identifies a specialist, individual, business group, or the like, that is primarily responsible for resolving, monitoring, or otherwise mitigating each of the identified incidents. The display 800 may also include a specialist 2 column 822 that identifies a manager, business group, regulatory group, or the like that is manages or otherwise oversees the work of the specialist identified under the specialist 1 column 820.

The display 800 may further include an open date column 824 that lists the date when the incident was officially opened or added to the display 800. A current resolution date column 826 lists a date when each of the identified incidents is expected, required, or desired to be resolved.

Finally, the display 800 may include an escalation action step(s) column 828 with numbered individual action steps accounted for with their own separate column. The escalation action step(s) column 828 lists a number of days until each of the action steps that make up the overall escalation action step are to be completed. Once each individual action step is concluded, the display 800 may provide a color coded, shaded, or other alteration to the cell within the column to indicate that the action step has closed. When an individual action step is within a predetermined period of time before the action step is to be due, the display 800 may highlight, or otherwise alter the cell for that action step to bring a viewer's attention to the need for the specific individual action step to be resolved soon. Similarly, if an individual action step is past its due date, the display 800 may highlight the cell in red, may bold the number, or may otherwise bring a viewer's attention to the fact that an individual action step has not been completed by the due date and therefore needs to be completed as soon as possible.

An example of the effectiveness of the escalation action step(s) column 828 is shown in FIG. 8, where the first-listed incident has completed the first two individual action steps of its three individual action steps that make up the total escalation action. The specialist assigned the triggering escalation action for this first-listed incident has fifteen days to complete the third and final individual action step, which would resolve the first-identified incident overall. The second-identified incident has one individual action step completed, but its second and final individual action step is due in five days, so the specialist tasked with the triggering escalation action for the second-identified incident has five days to implement the second individual action step. The third-identified incident has not completed either of its two individual action steps, and is three days late on the completion of the first individual action step. Finally, the fourth-identified incident has completed the first individual action step, and has twenty and ninety days, respectively, for the specialist to complete the remaining two individual action steps and resolve the fourth-identified incident overall.

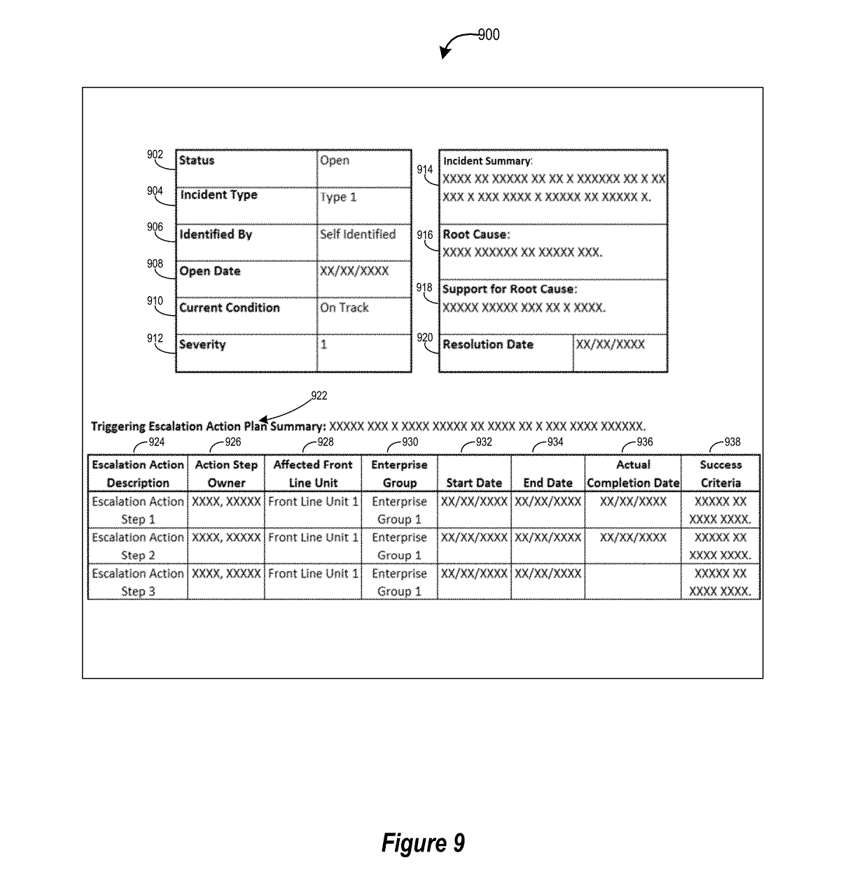

Turning now to FIG. 9, a sample display 900 is provided for an incident monitoring model that provides a detailed view of an individual incident. The display 900 includes a status data field 902, an incident type data field 904, an “identified by” data field 906, an open date data field 908, a current condition data field 910, and a severity data field 912. Additionally, the display provides a written incident summary field 914, a written root cause field 916, a support for root cause field 918, and a resolution date data field 920.

The display 900 may also include a written escalation action plan summary 922 that describes which individual action steps are to be implemented (including order of the steps when necessary) to resolve the incident. Additional information for resolving the incident using the action steps is included through the escalation action description column 924 (e.g., description of each individual action step), the action step owner column 926 (e.g., one or more specialists), the affected front line unit column 928, the enterprise group column 930 (e.g., the EPO unit name), the start date column 932 (e.g., lists start date for each individual action step), the end date column 934, the actual completion date column 936, and the success criteria column 938 (e.g., a description of how to determine when each individual action step has been successfully completed). This display 900 allows an individual specialist to determine how best to allocate resources to resolve or otherwise mitigate certain incidents. Furthermore, the display 900 allows a managing employee or oversight employee to inspect individual incidents at a detailed level within the incident monitoring model to identify incidents that may be root causes of incidents in other front line units.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for triggering enterprise-wide actions in response to detecting events from distributed front line units, the system comprising:
a memory device; and
a processing device operatively coupled to the memory device, wherein the processing device is configured to execute computer-readable program code to:
receive event data associated with a plurality of distributed front line units within an enterprise;
identify, from the received event data, a new event comprising at least a new incident, an affected front line unit of the distributed front line units, and at least one incident keyword associated with the new incident;
compare the affected front line unit and the new incident to an incident monitoring database;
determine, based on the comparison, a triggering escalation action associated with the new incident and a specialist associated with the new incident or the affected front line unit;
communicate the triggering escalation action to a computing device of the specialist; and
compile (i) the identified new event, the new incident, the affected front line unit, the triggering escalation action associated with the new incident, and the at least one incident keyword with (ii) a set of other identified events, other incidents, other affected front line units, other triggering escalation actions associated with the other incidents, and other incident keywords associated with the plurality of front line units to generate an incident monitoring model, wherein each of the other identified events, the other incidents, the other triggering escalation actions associated with the other incidents, and the other affected front line units are each linked to one or more incident keywords that comprise the at least one incident keyword associated with the new incident.

2. The system of claim 1, wherein the processing device is further configured to execute computer-readable program code to:
receive, from a computing device of a user, a monitoring theme request comprising a first incident keyword of the at least one incident keyword;
display, via the incident monitoring model, information about the identified new event, the new incident, and the affected front line unit; and
display, via the incident monitoring model, one or more of the other identified events linked with first incident keyword, one or more of the other incidents linked with the first incident keyword, one or more of the other affected front line units linked with the first incident keyword, and one or more of the other triggering escalation actions linked with the first incident keyword.

3. The system of claim 1, wherein the incident monitoring model comprises at least one of (i) a chart of the identified new event and the set of other identified events, as compared to status and time to completion information; (ii) a chart of the identified new event and the set of other identified events, as compared to ownership information; (iii) a chart of the identified new event and the set of other identified events, as compared to severity information; (iv) a chart of the identified new event and the set of other identified events, as compared to event data trends for the plurality of front line units within the enterprise; and (v) a map denoting status information for the identified new event and each of the set of other identified events across the enterprise.

4. The system of claim 1, wherein the processing device is further configured to execute computer-readable program code to:
monitor a status of the new event;
determine, based on the monitoring, that the status of the new event is normal; and
in response to determining that the status of the new event is normal, communicate a conclusion notification for the triggering escalation action to the computing device of the specialist.

5. The system of claim 1, wherein the processing device is further configured to execute computer-readable program code to:
monitor a status of the triggering escalation action;
determine, based on the monitoring, that the status of the triggering escalation action is complete; and
communicate a conclusion notification for the triggering escalation action to the computing device of the specialist.

6. The system of claim 1, wherein receiving the event data comprises establishing a secure dedicated communication link to servers of each of the plurality of front line units and monitoring the servers of each of the plurality of front line units to identify the event data in real time.

7. The system of claim 1, wherein receiving the event data comprises importing data feeds comprising the event data from each of the plurality of distributed front line units within the enterprise and monitoring the imported data feeds for the new event in real time.

8. The system of claim 1, wherein the processing device is further configured to execute computer-readable program code to:
in response to determining the triggering escalation action associated with the new incident, determine a priority ranking of the determined triggering escalation action; and
determine that the priority ranking of the determined triggering escalation action is below a priority ranking of a different triggering escalation action;
wherein communicating the triggering escalation action to the computing device of the specialist further comprises communicating instructions to defer execution of the triggering escalation action until the different triggering escalation action is fully executed.

9. The system of claim 1, wherein the incident monitoring database comprises a relational database that links or associates the event data with stored triggering escalation actions.

10. A computer program product for triggering enterprise-wide actions in response to detecting events from distributed front line units, the computer program product comprising at least one non-transitory computer readable medium comprising computer readable instructions, the instructions comprising instructions for:
receiving event data associated with a plurality of distributed front line units within an enterprise;
identifying, from the received event data, a new event comprising at least a new incident, an affected front line unit of the distributed front line units, and at least one incident keyword associated with the new incident;
comparing the affected front line unit and the new incident to an incident monitoring database;
determining, based on the comparison, a triggering escalation action associated with the new incident and a specialist associated with the new incident or the affected front line unit;
communicating the triggering escalation action to a computing device of the specialist; and
compiling (i) the identified new event, the new incident, the affected front line unit, the triggering escalation action associated with the new incident, and the at least one incident keyword with (ii) a set of other identified events, other incidents, other affected front line units, other triggering escalation actions associated with the other incidents, and other incident keywords associated with the plurality of front line units associated with the plurality of front line units to generate an incident monitoring model, wherein each of the other identified events, the other incidents, the other triggering escalation actions associated with the other incidents, and the other affected front line units are each linked to one or more incident keywords that comprise the at least one incident keyword associated with the new incident.

11. The computer program product of claim 10, wherein the computer readable instructions further comprise instructions for:
receiving, from a computing device of a user, a monitoring theme request comprising a first incident keyword of the at least one incident keyword;
displaying, via the incident monitoring model, information about the identified new event, the new incident, and the affected front line unit; and
displaying, via the incident monitoring model, one or more of the other identified events linked with the first incident keyword, one or more of the other incidents linked with the first incident keyword, one or more of the other affected front line units linked with the first incident keyword, and one or more of the other triggering escalation actions linked with the first incident keyword.

12. The computer program product of claim 10, wherein the incident monitoring model comprises at least one of (i) a chart of the identified new event and the set of other identified events, as compared to status and time to completion information; (ii) a chart of the identified new event and the set of other identified events, as compared to ownership information; (iii) a chart of the identified new event and the set of other identified events, as compared to severity information; (iv) a chart of the identified new event and the set of other identified events, as compared to event data trends for the plurality of front line units within the enterprise; and (v) a map denoting status information for the identified new event and each of the set of other identified events across the enterprise.

13. The computer program product of claim 10, wherein the computer readable instructions further comprise instructions for:
monitoring a status of the new event;
determining, based on the monitoring, that the status of the new event is normal; and
in response to determining that the status of the new event is normal, communicating a conclusion notification for the triggering escalation action to the computing device of the specialist.

14. The computer program product of claim 10, wherein the computer readable instructions further comprise instructions for:
monitoring a status of the triggering escalation action;
determining, based on the monitoring, that the status of the triggering escalation action is complete; and
communicating a conclusion notification for the triggering escalation action to the computing device of the specialist.

15. The computer program product of claim 10, wherein receiving the event data comprises establishing a secure dedicated communication link to servers of each of the plurality of front line units and monitoring the servers of each of the plurality of front line units to identify the event data in real time.

16. The computer program product of claim 10, wherein receiving the event data comprises importing data feeds comprising the event data from each of the plurality of distributed front line units within the enterprise and monitoring the imported data feeds for the new event in real time.

17. The computer program product of claim 10, wherein the computer readable instructions further comprise instructions for:
in response to determining the triggering escalation action associated with the new incident, determining a priority ranking of the determined triggering escalation action; and
determining that the priority ranking of the determined triggering escalation action is below a priority ranking of a different triggering escalation action;
wherein communicating the triggering escalation action to the computing device of the specialist further comprises communicating instructions to defer execution of the triggering escalation action until the different triggering escalation action is fully executed.

18. The computer program product of claim 10, wherein the incident monitoring database comprises a relational database that links or associates the event data with stored triggering escalation actions.

19. A computer implemented method for triggering enterprise-wide actions in response to detecting events from distributed front line units, said computer implemented method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving event data associated with a plurality of distributed front line units within an enterprise;
identifying, from the received event data, a new event comprising at least a new incident, an affected front line unit of the distributed front line units, and at least one incident keyword associated with the new incident;
comparing the affected front line unit and the new incident to an incident monitoring database;
determining, based on the comparison, a triggering escalation action associated with the new incident and a specialist associated with the new incident or the affected front line unit;
communicating the triggering escalation action to a computing device of the specialist; and
compiling (i) the identified new event, the new incident, the affected front line unit, the triggering escalation action associated with the new incident, and the at least one incident keyword with (ii) a set of other identified events, other incidents, other affected front line units, other triggering escalation actions associated with the other incidents, and other incident keywords associated with the plurality of front line units associated with the plurality of front line units to generate an incident monitoring model, wherein each of the other identified events, the other incidents, the other triggering escalation actions associated with the other incidents, and the other affected front line units are each linked to one or more incident keywords that comprise the at least one incident keyword associated with the new incident.

20. The computer implemented method of claim 19, further comprising:
receiving, from a computing device of a user, a monitoring theme request comprising a first incident keyword of the at least one incident keyword;
displaying, via the incident monitoring model, information about the identified new event, the new incident, and the affected front line unit; and
displaying, via the incident monitoring model, one or more of the other identified events linked with the first incident keyword, one or more of the other incidents linked with the first incident keyword, one or more of the other affected front line units linked with the first incident keyword, and one or more of the other triggering escalation actions linked with the first incident keyword.
